(19) United States
(12) Patent Application Publication
(10) Pub. No.: US 2012/0233488 A1
(43) Pub. Date: Sep. 13, 2012

(54) ADJUSTMENT OF A PROCESSOR FREQUENCY

(75) Inventors: Artur Tadeusz Burchard, Eindhoven (NL); Petr Kourzanov, Eindhoven (NL)

(73) Assignee: NXP B.V., Eindhoven (NL)

(21) Appl. No.: 13/055,151

(22) PCT Filed: Jul. 21, 2009
(86) PCT No.: PCT/IB2009/053162

§ 371 Date: Jan. 21, 2011

(30) Foreign Application Priority Data
Jul. 23, 2008 (EP) 08104848.0

(51) Int. Cl. G06F 1/04

(52) U.S. Cl. 713/500

(57) ABSTRACT

A system comprises a processor, a connection to the processor, a monitoring component arranged to monitor the connection to the processor, a performance counter connected to the monitoring component and arranged to establish a ratio between processor idle time and processor busy time, and a policy component connected to the performance counter and the processor, and arranged to adjust the processor frequency according to the established ratio of processor idle time to processor busy time.

This invention relates to a method of operating a system, and to the system itself.

Power management is increasingly important in today's electronic systems, due to ever increasing functionality of portable and mobile devices, which have limited energy sources. Especially, dynamic power management gains lately more importance due to the increasing variability of applications and the associated variability of processing that is needed to execute such applications. Moreover, the appearance of enabling technologies allow for the fast and efficient control of delivered power, due to fast control of clock frequency and supply voltage of integrated circuits dynamic power management becomes truly possible. These techniques allow dynamic adaption of delivered power of integrated circuits to match in time the required temporal workload of an application.

A specific application executed on a specific hardware puts a certain level of workload for a certain period of time measured as a ratio of execution time and the total time available for a hardware block (or alternatively as a ratio of a number of clock cycles used for computation and the total number of available clock cycles for a defined period). As frequency scaling changes, processing capabilities of a hardware block and together with voltage scaling which scales power dissipated by that hardware, changing frequency provides a trade off between these two quantities.

During run-time, a processor is busy or is idle. When busy, a processor executes application that consists of tasks. When an application finishes, thus there are no tasks scheduled for execution processor goes into idle. Also, when during execution a task is blocked by I/O access and no other task is ready to execute, the processor goes also into idle. In idle, a special task is scheduled by an operating system (OS), the idle( ) task, whose role is to lower down power consumption by executing NO-OP instructions and/or disabling unused hardware blocks, while keeping processor responsive.

Depending on the processor and on the OS, the idle( ) task can have different implementations. It can have a special instruction, a halt instruction, which disables parts of the processor. The idle( ) task can also be implemented as a sequence of simple instructions that as a result do not change the processor state. To reduce power, the idle( ) task often implements clock gating of the processor. Usually, at the beginning of execution of idle( ) task, a special register (often memory-mapped i/o (MMIO) register) is written with a clock gating instruction. Exit from clock gating is done on any processor interrupt, including OS tick interrupt.

Other improvements in CPU power management are known. For example, United States of America Patent Application Publication 2005/0071688 discloses a hardware CPU utilization meter for a microprocessor. In the system of this Publication, a hardware based solution to CPU utilization and power management is provided that avoids an additional set of software tasks to monitor CPU utilization. The system has a CPU, a counter; a monitor, and a clock. The clock provides a CLK signal to the counter when a software task is running on the CPU, and the counter counts the number of clock pulses since a RESET. The monitor samples and holds the value of the counter at the last RESET. The counter outputs a signal to the monitor that is responsive to the count content at the time of the last reset. The monitor outputs this value as a control signal. This control signal may be a power control signal, a function control signal, or even a clock control signal, responsive to count content. As an example, the counter may output a control signal reducing power input or clock pulse input to the CPU responsive to monitor value when the CPU utilization is below a threshold.

The system of this Publication does not provide a hardware solution that is sufficiently robust to the delivery of power saving. For example, a decrease in clock speed for a processor will still result in the same perceived processor load, as the system is monitoring clock pulses since a reset. This and other weaknesses do not provide a sufficient hardware solution to the problem of managing power consumption during variable processor load.

It is therefore an object of the invention to improve upon the known art. According to a first aspect of the present invention, there is provided a method of operating a system, the system comprising a processor, a connection to the processor, a monitoring component, a performance counter connected to the monitoring component, and a policy component connected to the performance counter, the method comprising the steps of monitoring the connection to the processor, at the monitoring component, establishing a ratio between processor idle time and processor busy time, at the performance counter, and adjusting the processor frequency according to the established ratio of processor idle time to processor busy time, at the policy component.

According to a second aspect of the present invention, there is provided a system comprising a processor, a connection to the processor, a monitoring component arranged to monitor the connection to the processor, a performance counter connected to the monitoring component and arranged to establish a ratio between processor idle time and processor busy time, and a policy component connected to the performance counter and the processor, and arranged to adjust the processor frequency according to the established ratio of processor idle time to processor busy time.

Owing to the invention, it is possible to provide an improved power management enabling technology for dynamic power management that allow for even more adaptive schemes. An average workload can be calculated for a certain period of time (calculated as a ratio of busy time and total time) and the frequency can be reduced such that idle time is being reduced. This allows processor to operate on lower frequency and thus lower voltage thereby saving power. Thus, the idle( ) based clock gating would become obsolete. Such control provided by the system can ideally be done on a fine grain because for data dependent processing the exact knowledge about deadlines/processing times (and idle cycles as a result) is observable during runtime. Solving this in software is very costly, the more fine grain the more costly it becomes. The hardware solution of the invention provides a fine grain solution that has many advantages.

In a first embodiment, the connection to the processor comprises an address line and the monitoring component is arranged to detect that the processor is addressing an idle loop task. In a second embodiment, the connection to the processor comprises a data line and the monitoring component is arranged to detect a pattern of instructions indicating an idle loop task. In these two possibilities, the invention consists of an off-core, but on-chip hardware integrated with the hardware cache memory that triggers on access to the cache-lines that contain the idle-loop code. By monitoring accesses to these cache-lines (from the processor core) the new hardware can maintain a counter that reflects the ratio of active/idle clocks, and can use this counter to set the corresponding operating points (voltage/frequency pairs).

This feedback loop will stabilize on the optimal operating point for a given workload. The instruction cache is accessed by the processor through address line, which indicates the location of an instruction to be fetched by a processor. This instruction is thereafter transferred through, a data line of the instruction cache. Thus, two possibilities exists for observing whether idle( ) program code has been accessed, observing of an instruction cache address line or observing an instruction cache data line.

In a third embodiment, the connection to the processor comprises an output from a clock gate register and the monitoring component is arranged to detect a clock gate signal indicating an idle loop task. In this embodiment, to support the improved mechanism, a small hardware addition is implemented that reacts on changes in the special clock-gating register and gates the clock of the processor on every entry to idle( ) task. Also, this hardware is responsible for enabling the clock on any interrupt; this is done by observing the interrupt line of the processor and reacting on it.

Embodiments of the present invention will now be described, by way of example only, with reference to the accompanying drawings, in which:

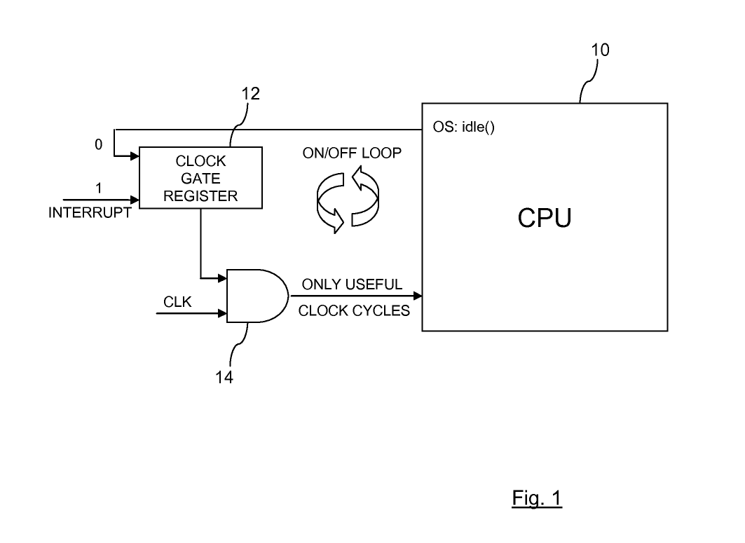

FIG. 1 is a schematic diagram of a prior art system,

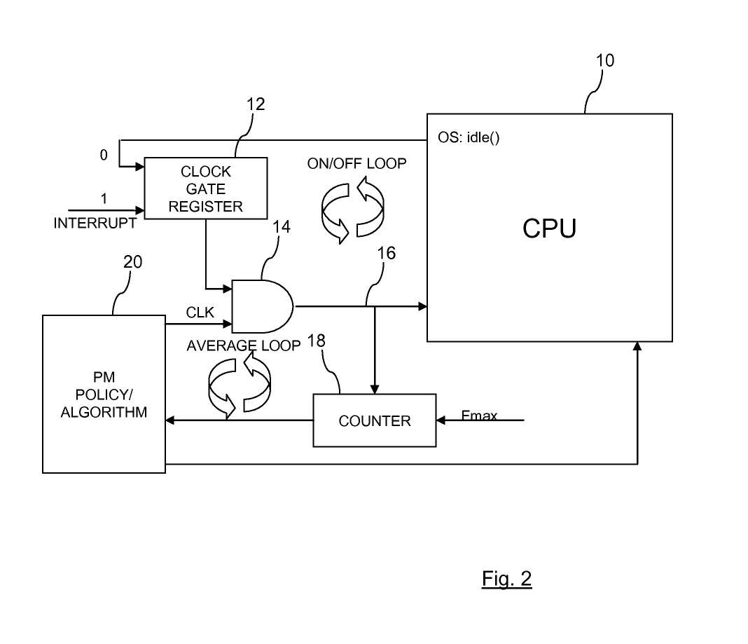

FIG. 2 is a schematic diagram of a first embodiment of the system according to an example of the invention,

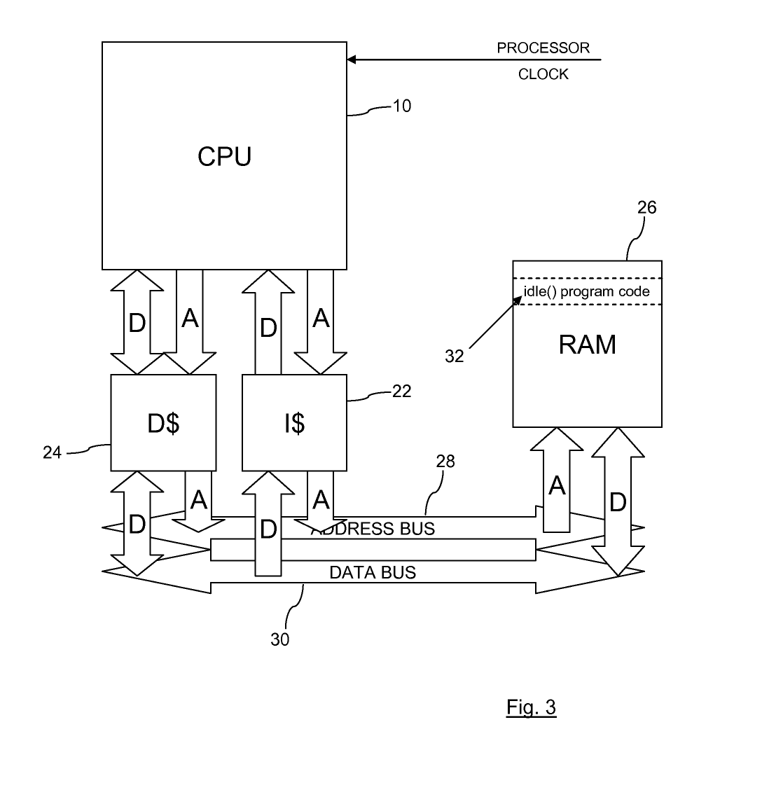

FIG. 3 is a schematic diagram of a second prior art system,

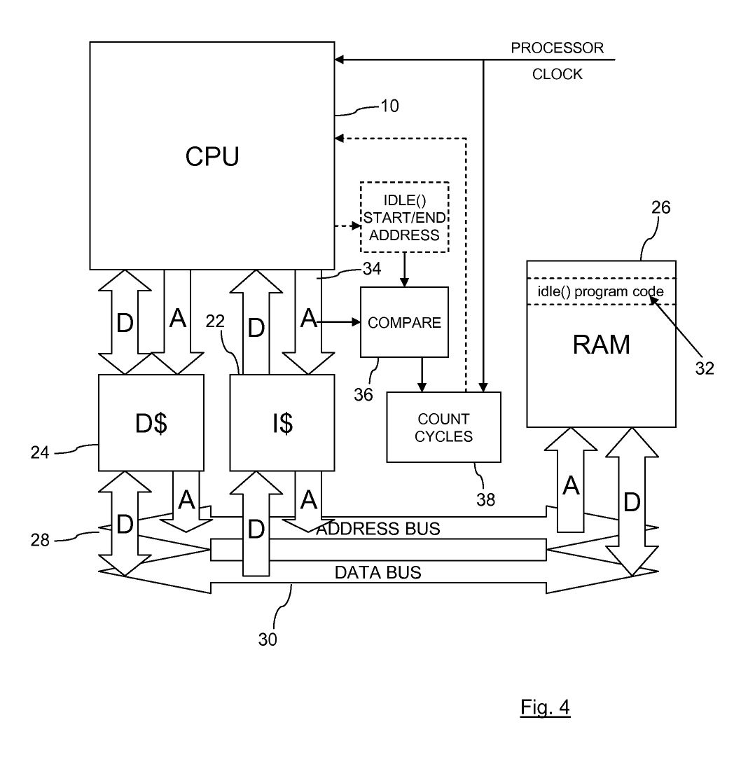

FIG. 4 is a schematic diagram of a second embodiment of the system according to an example of the invention,

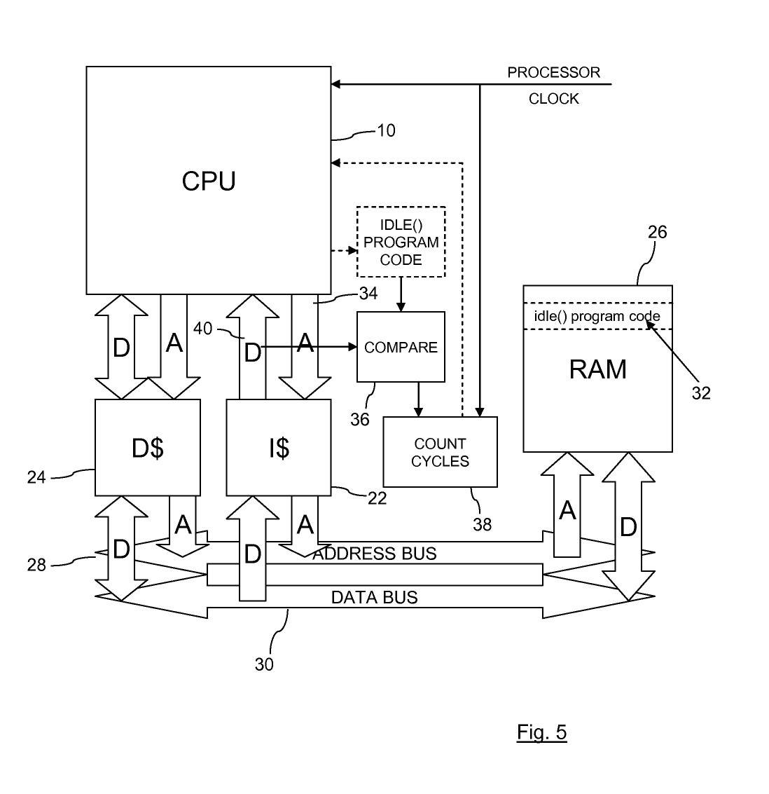

FIG. 5 is a schematic diagram of a third embodiment of the system according to an example of the invention,

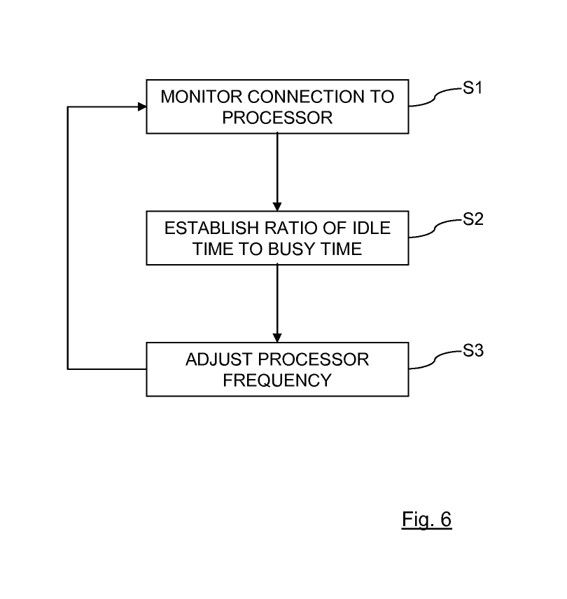

FIG. 6 is a flowchart of a method of operating the system,

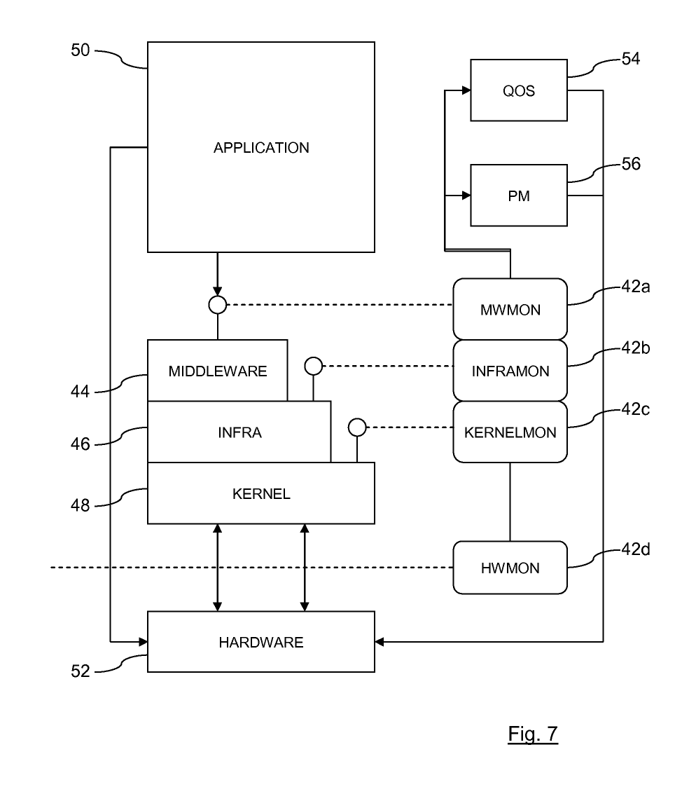

FIG. 7 is a schematic diagram of a system for determining application periodicity, and

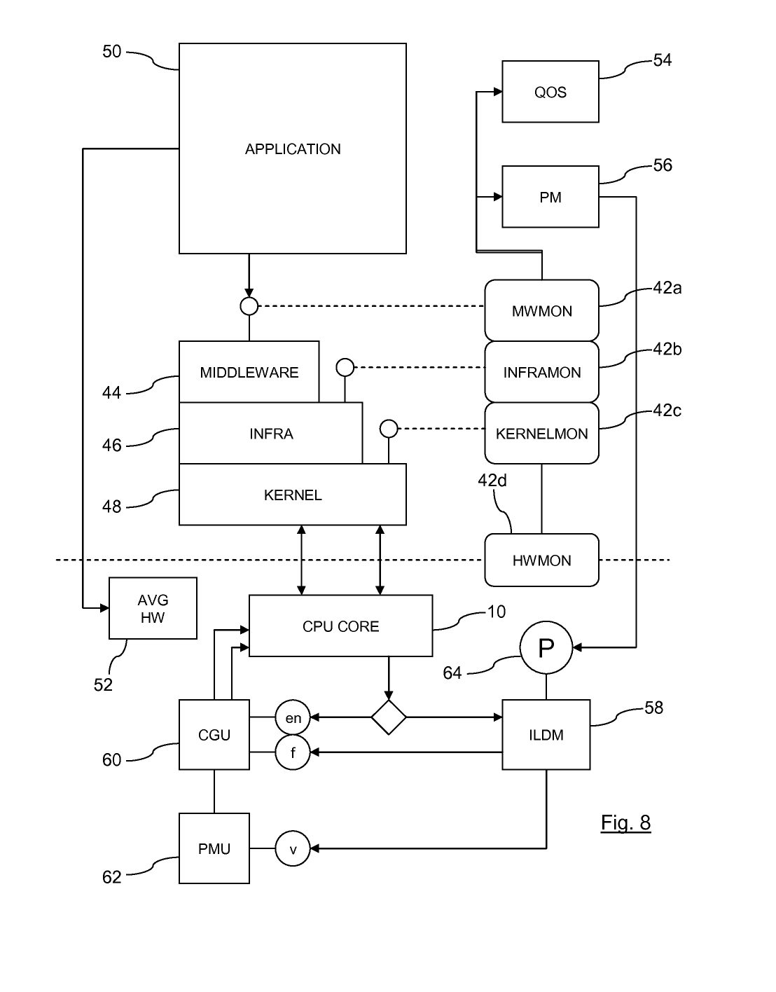

FIG. 8 is a schematic diagram of the system of FIG. 7, combined with the idle loop detection mechanism.

An example implementation of state of the art idle( ) task based power management (clock gating) is shown in FIG. 1. In this Figure, the known idle( ) task based clock gating is illustrated. A processor 10 is connected to a clock gate register 12 and to a component 14, which receives a clock signal and an output from the clock gate register. An example implementation of idle( ) task can be found in pSOS operating system (in NDK 5.× and above) for NXP TM3260 and above TriMedia family of processors. Once the processor 10 is instructed to perform the OS:idle( ) task, this task sets the clock gate register 12 to gate/block the CLK signal, and the processor 10 will stop and stay in this mode until an interrupt (including an OS Tick interrupt) changes back the clock gate register 12, so that the CLK signal is made available to the processor 10. This then provides an output to the component 14, which ensures that only useful clock cycles are used by the processor 10.

Fine-grained power management control software is hard to be correctly designed and implemented. This is manifested by two problems: fine time grain workload observation and exponential increase in overhead when decreasing power control time resolution. Current software based approaches to control frequency to match the average observed workload work on rather course time grain, as the atomic workload observation period for software is the OS tick period (usually larger than 10 μs). A substantial number of OS ticks are needed to come to an accurate average, thereby increasing the control period even further. There is an exponential increase in the overhead needed when decreasing power control time resolution. Considering an instruction-level software control as an example: several to tens of additional instructions would be needed to come to a conclusion about a desired frequency needed for a particular set of instructions. Yet another solution to this problem is static control introduced to software using off-line analysis, during compilation for example. However, this does not solve dynamic relations, especially when a number of tasks are dynamically scheduled by the operating system. Existing hardware solutions, for performing power management control, lack the ability to automatically adjust the operating point. They depend on software for prediction and/or control, and they have no decision and intelligence components.

The hardware idle-loop detection mechanism provided by the invention of the present application addresses the shortcomings of the software only solutions by monitoring activity at a cycle level. New hardware partly takes responsibility of setting the operating points from software, as these can be calculated by measuring the clock-gating activity externally to the core. Reducing of processor frequency can be straightforward, as it can be assumed that a linear relation exists between frequency and workload. If the observed workload (the ratio of processor clock cycles after clock gating to the all available clock cycles per certain period) is decreasing the frequency should decrease with the same ratio. Thus the reducing of frequency delivered by the hardware will be completely transparent to the software. In order to increase the processor frequency something extra is required: a threshold mechanism (increase frequency when the workload increases above certain value), equalizer mechanism (return to maximum frequency on certain events, on interrupts for example) or standard software based control can be used.

In a first embodiment, the invention consists of an off-core, but on-chip hardware group that observes and triggers on an embedded microcontroller CPU clock line that is equipped with the idle( ) based clock-gating function. By monitoring the status of the clock (enable/disable clock-gating) the hardware can maintain the counter that reflects the ratio of active/idle clocks, and use this counter to set the corresponding operating points (voltage/frequency pairs). This feedback loop will stabilize on the optimal operating point for a given workload. Therefore, extending the idle( ) based clock gating (on/off loop) with an averaging loop brings the benefits of reduced number of idle cycles together with reducing the operating frequency, thereby spreading the workload, to keep the processor utilized all the time. The reduced frequency, and thus reduced voltage, result in a lower power operating regime for the microprocessor, in its operation. This mechanism is automatic for the processor and transparent for the executed software.

An example implementation of the automatic adaptive frequency and voltage mechanism (averaging loop) is shown in FIG. 2. In this improved system there is the processor 10, with a connection 16 to the processor being monitored by a monitoring component and performance counter 18 arranged to monitor the connection 16 to the processor 10, and arranged to establish a ratio between processor idle time and processor busy time. The counter 18 receives as an input fₘₐₓ, which is the maximum possible frequency of the processor 10. Additionally, there is a policy component 20, connected to the performance counter 18 and the processor 10 (indirectly), and is arranged to adjust the processor frequency according to the established ratio of processor idle time to processor busy time.

Based on clock observation, the frequency can be therefore adjusted. Example calculation for adjusted frequency can be described by the following equation:

f_{reduced}=fₘₐₓ*N_{bc}/Nₜₒₜ,

where
N_{bc}=number of clock cycles on line 16, which are busy clock cycles, equal to (total−idle cycles)
Nₜₒₜ=number of all available clock cycles per period when processor would run at fₘₐₓ.

To increase processor frequency there is needed another mechanism. A number of different ones can be used, for example a threshold mechanism (increase frequency when the workload increases above certain value), or equalizer mechanism (return to maximum frequency on certain events, on interrupts for example) or standard software based control can be used. Also return to maximum frequency can be carried out based on calculated/observed application events.

The hardware idle-loop detection mechanism off-loads the software from working out load prediction and power management control by using a simple counter that measures relative load on the microcontroller CPU core. The advantages of the solution include more power saved, a faster average working time, a finer grain control, a system that is cheaper in terms of development cost, and is easier to implement (integration), with plug-in external component without changing software and microprocessor architecture. The system provides lower overheads (no software involved) and power consumption (tiny special purpose hardware block). No adaptation of the microcontroller CPU core is required, the new hardware block(s) is core agnostic (the system only requires the core hardware and software to implement the clock-gating function). Because the new hardware counts at cycle level, all cycles are taken into account, so the solution of FIG. 2 results in a more accurate measure when compared to software solutions. Any product containing any microprocessor can benefit from the improvement delivered by the solution of FIG. 2.

Other embodiments of the invention can utilise processor communication with instruction and data caches. During boot, total memory space is divided between different resources in the silicon on the chip. Part of the memory space is reserved for the operating system which loads its code there. The size of OS memory space is usually fixed, the start address usually as well, but both might be dynamically allocated (only) during boot. Nevertheless, both are known after the boot time. Within the OS memory address space, a program code of idle( ) task will be located. Its address offset to the OS memory space start address is fixed, known already during compile/link time.

Therefore, at the latest just after the boot (sometimes already after compilation/linking), the exact start address of idle( ) task code is known. Most of processors 10 access memory through caches. A standard microprocessor system is shown on FIG. 3. Usually an instruction cache 22 (I$) and data cache 24 (D$) are separated, the first being used for accessing program code, the second for accessing program data. Both are connected on one side to a processor 10 and on the other side to system memory 26, through memory address bus 28 (A) and memory data bus 30 (D). Usually, instruction cache 22 is read-only by the processor 10. The program code for the idle( ) task is shown schematically as the code 32, being a section of the system memory 26 defined by start and end addresses (shown schematically as the dashed lines).

A second embodiment of the invention uses a cache-based idle-loop detection mechanism which, as in the first embodiment, addresses the shortcomings of the software-only solution by monitoring activity on an cache-line level. The new hardware partly takes responsibility of setting the operating points from software, as these can be calculated by measuring the frequency of access to the cache-lines containing the idle-loop code externally of the CPU core. The system workload can thus be calculated by observing the access to a cache. The clock cycles during which an instruction outside of idle( ) memory space is accessed are counted as busy, the clock cycles during which an instruction from idle( ) memory space is accessed are counted as idle. The ratio between busy (or total minus idle) and the total number of available cycles is the average workload and is linearly related to the operating frequency.

Once the new frequency has been calculated, the reducing of the frequency can be straightforward, as the system can assume a linear relation between frequency and workload. If the observed workload (the ratio of processor busy cycles to the all available clock cycles for certain period) is decreasing the frequency should decrease with the same ratio. Thus reducing of frequency will be completely transparent to the software. As before, in order to increase the frequency something extra is required: a threshold mechanism (increase frequency when the workload increases above certain value), equalizer mechanism (return to maximum frequency on certain events, on interrupts for example) or a standard software based control can be used.

The second embodiment consists of an off-core, but on-chip hardware group integrated with the hardware cache memory that is triggered by an access to the cache-lines that contain the idle-loop code. By monitoring accesses to these cache-lines (from the CPU core) this hardware can maintain a counter that reflects the ratio of active/idle clocks, and can use this counter to set the corresponding operating points (voltage/frequency pairs). This feedback loop will stabilize on the optimal operating point for a given workload.

The instruction cache 22 is accessed by the processor 10 through the address line, which indicates the location of an instruction to be fetched by the processor 10. This instruction is thereafter transferred through a data line of the instruction cache 22. Thus, two possibilities exists for observing whether idle( ) program code has been accessed, observing of an instruction cache address line or observing an instruction cache data line. This embodiment of the invention provide address line based idle( ) code detection.

As explained above, the address of the idle( ) program code is known and fixed during run-time. Therefore, a straightforward observation of the address line of the instruction cache 22 of the processor 10 and comparison with a idle( ) memory range will enable the system to effectively and accurately count busy and idle clock cycles. An example implementation is shown in FIG. 4, where dashed lines indicate software actions.

In this example, the address line 34 is being monitored by a monitoring component 36, which communicates with a counter 38, which is arranged to count and store useful/busy (none idle) clock cycles of the processor 10. A software instruction from the processor 10, at address space initialisation, communicates the start and end addresses of the idle task( ) in the memory 26 to the monitoring unit 36. The unit 36 monitors the address line 34, and can tell when the processor 10 is addressing the memory space associated with the idle task( ) and communicates this to the counter 38. This allows the counter 38 to establish a ratio between amount of time when the processor 10 is busy and when the processor 10 is idle, and the counter 38 can inform the power management of the processor 10 accordingly.

The third embodiment of the invention is shown in FIG. 5, which provides data based idle( ) code detection. If for any reason the address line observation is not possible, as an alternative the system can observe a data line 40 of the instruction cache 22. The idle( ) program code has a specific pattern of instructions, which can be observed during run-time. Based on recognition of occurrences of this pattern, the number of busy and idle clock cycles can be easily calculated. An example implementation is shown in FIG. 5, where again the dashed lines indicate software actions. At initialisation, the idle task( ) program code can be communicated to the monitoring component 36, which then monitors the data line 40 for patterns that match the known program code. This allows detection of the ratio of idle to busy time, and as in the previous two embodiments, this can then be used to adjust the frequency of the processor 10. Both of the embodiments of FIGS. 4 and 5 deliver the same advantages as the first embodiment of FIG. 2.

There are effectively two solutions, hardware and software. In software the counter 38 just counts processor cycles when the unit 36 instructs it to count (when idle( ) is detected). The counter 38 then just informs the processor 10 about the absolute count and a software power manager (not shown) takes this information as an input and establishes the ratio and subsequently changes the frequency of the processor 10. In a hardware solution the counter 38 in FIG. 5 is in principle the same as counter 18 in FIG. 2. This counter 38 would also need to receive Fmax to be able to come to a ratio. Then some hardware power manager (similar to unit 20 in FIG. 2) would be informed to change the clock.

The methodology of the three embodiments is summarised in FIG. 6. The first step of the process is step S1, which comprises the monitoring of the connection to the processor 10 whether that is a clock signal or an address or data line. This process step is carried out by the monitoring component. The next step is the step S2, of establishing a ratio between the processor idle time and the processor busy time. This is carries out at the performance counter. The final step comprises the adjusting of the processor frequency, according to the established ratio of processor idle time to processor busy time, which is carried out at the policy component. The method is a continuous process, as illustrated by the arrow looping round from step S3 to step S1. At some instances the frequency of the processor 10 will be reduced, as a result of steps S1 and S2, and at other times, the frequency of the processor 10 will be increased. The process provides a continuous adaption of the processor frequency. The steps are described as being carried out by three separate components, a monitoring component, a performance counter, and a policy component. However, these individual functions can be combined, either into a single unit, or a pair of units, with the functions spread between the two units in the pair.

The hardware fine grain adjustment in the processor frequency can also be combined with software control of any application being run, to improve the overall power efficiency. The software component can be used to provide automated discovery of application periodicity. A centralized management system can be used that includes monitoring of the application activities (such as OS calls, special-purpose hardware access) and calculation of effective periods and/or deadlines. The system is application-neutral and can cope with multiple applications running in parallel. One advantage of this system is that it supports a simplified application software development.

Current soft and hard real-time applications incorporate explicit periodicity/deadline management code next to the actual functional code. Current best-effort applications typically do not incorporate such management code while still potentially exhibiting periodic behaviour. Soft real-time and best-effort software often exhibit emerging pseudo real-time properties, especially in AVG (advanced video graphics) processing. To improve user experience, the corresponding deadlines must be monitored and the power management or QoS (quality of service) levels adjusted to match the user expectation. Since these deadlines are often unpredictable (i.e. data-dependent), they are typically explicitly set by the application. This hard-coding approach is error-prone and labour intensive, since the application designer/implementor has to orchestrate the control of power management, QoS and deadline miss detection. Emerging periodicity provides an extra opportunity for system optimization in multi-function devices (where many applications are running in parallel). This opportunity cannot be taken when every application controls power management or QoS on its own and monitors its own deadline misses.

In addition to the monitoring of the hardware processor idle time, the system can be further improved to monitor hardware/software components in order to automatically calculate application periods and detect deadline misses. By using time-frequency analysis, the monitoring can differentiate periods and/or deadlines of multiple applications all running in parallel. In general, applications use a well-defined interface to functions provided by the OS (OS API) or special-purpose hardware, and there is a hardware/software mechanism for installing and triggering on timeout events (watchdog).

FIG. 7 illustrates hardware/software monitors 42 being placed at the border between the application software code and the operating system (OS) software code or special-purpose hardware. The monitors 42 comprise a middleware monitor 42a, an infra monitor 42b, a kernel monitor 42c and a hardware monitor 42d, respectively monitoring the middleware 44, the infra 46, the kernel 48 and calls from the kernel 48 and application 50 to the hardware 52. The QoS unit 54 and power management unit 56 are also shown in the Figure.

The monitors 42 are capable of intercepting/monitoring OS calls and/or direct hardware accesses that are initiated by the application 50 via OS Application Program Interface (API) or Application Binary Interface (ABI). Certain calls/accesses are triggered by periodic processing within the application, which is reflected in the calling/access frequency. By carefully selecting relevant calls/accesses during design time (given a number of functions the device has to perform, for example audio player or a graphics accelerator), the hardware/software monitors 42 can observe the actual application periodicity at run-time. For example, for streaming media, these calls will include FIFO synchronization primitives. Multiple frequencies for complex scenarios with multiple active applications can be extracted via time-frequency analysis. Once application periodicity is determined, a watchdog can be installed for that application to inform the application about (potential) missed deadlines. The monitors 42 are arranged to detect the periodicity of the executing application and the power management unit 56 is arranged to adjust the processor frequency according to the detected periodicity.

When periodicity of an application is found, the clock frequency at which the application executes can be reduced by a clock generation unit (and thus voltage by a power management unit as well in relation to the frequency) such that the application executes its functionality just-in-time (just before the subsequent execution is scheduled). This is possible only when the periodicity is known. A specific application executed on a specific hardware puts a certain level of workload for a certain period of time measured as a ratio of execution time and the total time available for a hardware block (or alternatively as a ratio of a number of clock cycles used for computation and the total number of available clock cycles for a defined period). As frequency scaling changes, processing capabilities of a hardware block and together with voltage scaling which scales power dissipated by that hardware, changing frequency provides a trade off between these two quantities.

Existing solutions require application awareness of their own periodicity and deadline management. This does not scale well to multi-application scenario, in which a centralized management system is required. The monitor solution of FIG. 7 is such a centralized management system that is closely cooperating with the OS SW and special-purpose HW that may exist in the platform. The advantages of the solution include the fact that it is scalable to multiple applications all running in parallel, no application adaptations are required for best-effort application class, soft- and hard real-time applications will be simplified by removing periodicity/deadline management code, and the separation of concerns between the applications (responsible for implementation of their own function) and the periodicity/deadline monitor (responsible for detection and communication of system-wide properties such as applications' periodicity/deadlines to other components such as QoS or PM manager) allows loose coupling between such managers and applications.

The software monitoring system of FIG. 7 can be combined into a two-level feedback control loop comprising the idle-loop detection mechanism of the first three embodiments, for fine-grained processor core-neutral power management and automated discovery of application deadline misses. This system includes two major sub-systems, firstly the fine-grained processor core-neutral idle-loop detection mechanism and secondly the centralized application-neutral period/deadline detection mechanism. The first sub-system is used to drive the power management parameters on a small scale (cycles, instruction) while the second is used to monitor the applications' performance yield as an effect of the change in the power management parameters. This feedback control loop provides guaranteed throughput at an optimal power consumption level.

Existing power management schemes require application- and core-specific adaptations. This is error-prone and labour-intensive. Also, many legacy applications exist that are difficult to analyse and/or re-engineer. The system of FIG. 7 provides a method of decoupling application functions from power management functions; however it does not address system-level power management objectives. Application periodicity/deadline management can not predict system-wide impact of controlling power management/QoS settings. The idle-loop detection mechanisms described above do not differentiate performance levels per application, but only on the system level.

Application of the idle-loop detection mechanisms require hardware setting of power management operating points from an additional unit, which monitors system-wide idleness. Application of the software system of FIG. 7 implies that also software may set the power management operating points. As a consequence, these separate control settings might clash, since the hardware-oriented unit is unaware of the software-oriented unit (and vice versa). Thus, a straightforward combination of an idle-loop detection mechanism with an automated application periodicity monitor does not give maximal power savings, or even might induce higher power consumption levels.

In FIG. 8, the idle-loop detection mechanism (ILDM) 58 is controlling the hardware setting of power management operating points via the clock generation unit (CGU) 60 and the power management unit (PMU) 62 together with the power management software, which leads to clashes (since these two units operate on different granularity levels) and potential loss of power efficiency. The solution is that, in addition to the mechanism 58 which calculates the relative load on the processor 10 that is core-agnostic and allows for fine-grained PM control (the idle loop detection) and the “gear” (monitors 42 and PM 56) for measuring application quality level as experienced by the user (FIG. 7), both elements being application- and core-neutral and allow for multiple applications to be running in the system, there is a feedback unit 64 between the mechanism and the gear that supports synchronization between the two.

The mechanism 58 includes special-purpose hardware for the idle-loop detection or higher-level control software that monitors the workload ratio counter (busy/idle cycles). The gear of FIG. 7 tracks deadline misses and includes a centralized hardware/software management system that monitors application periodicity, calculates the deadlines and reports deadline misses back to the application.

The feedback unit 64 relates the set of applications' periods to the resolution of the workload ratio counter of the idle-loop monitor (i.e., the frequency at which it runs). For example, the most basic relation is defined as follows: for a set of applications 1 . . . n with periods P₁ . . . Pₙ the corresponding resolution of the workload ratio counter could be R=min(P₁ . . . Pₙ)/2. So the frequency of the idle-loop monitor is F=1/R=2/min(P₁ . . . Pₙ)=max(F₁ . . . Fₙ)*2.

In FIG. 8, the feedback unit 64 is depicted as an additional interface 64 to the ILDM 58, which is used by the software power management 56 to set the resolution of the workload counter present in the ILDM 58. Thus, only the ILDM 58 is actually controlling the CGU 60 and the PMU 62 while the software power management 56 uses the feedback unit 64 to tune the resolution to the required level. Effectively, the feedback unit (64) is arranged to moderate the adjusting of the processor frequency according to the established ratio of processor idle time to processor busy time, according to the detected application periodicity.

Existing power management schemes rely on application knowledge for deadline miss management, while the solution of FIG. 8 provides a “gear” that can track deadlines in an automated way. Also, existing schemes are not scalable to multiple applications. Additionally this solution is not specific to a processor core. The advantages of the solution include scalability with respect to different applications and their numbers, flexibility in the choice of the processor core, and better power management in the face of changing workload requirements. The two-level loop supports fine-grain system-wide power management while still allowing simplified applications development with power management/QoS concerns addressed by a dedicated software component.

1. A method of operating a system, the system comprising a processor, a connection to the processor, a monitoring component, a performance counter connected to the monitoring component, and a policy component connected to the performance counter, the method comprising the steps of:
monitoring the connection to the processor, at the monitoring component,
establishing a ratio between processor idle time and processor busy time, at the performance counter, and
adjusting the processor frequency according to the established ratio of processor idle time to processor busy time, at the policy component.

2. The method according to claim 1, wherein the connection to the processor comprises an address line and the monitoring of the connection to the processor comprises detecting that the processor is addressing an idle loop task.

3. The method according to claim 1, wherein the connection to the processor comprises a data line and the monitoring of the connection to the processor comprises detecting a pattern of instructions indicating an idle loop task.

4. The method according to claim 1, wherein the connection to the processor comprises an output from a clock gate register and the monitoring of the connection to the processor comprises detecting a clock gate signal indicating an idle loop task.

5. The method according to claim 1, and further comprising detecting the periodicity of an executing application and adjusting the processor frequency according to the detected periodicity.

6. The method according to claim 5, further comprising moderating the adjusting of the processor frequency according to the established ratio of processor idle time to processor busy time, according to the detected periodicity.

7. A system comprising:
a processor,
a connection to the processor,
a monitoring component arranged to monitor the connection to the processor,
a performance counter connected to the monitoring component and arranged to establish a ratio between processor idle time and processor busy time, and
a policy component connected to the performance counter and the processor, and arranged to adjust the processor frequency according to the established ratio of processor idle time to processor busy time.

8. The system according to claim 7, wherein the connection to the processor comprises an address line and the monitoring component is arranged to detect that the processor is addressing an idle loop task.

9. The system according to claim 7, wherein the connection to the processor comprises a data line and the monitoring component is arranged to detect a pattern of instructions indicating an idle loop task.

10. The system according to claim 7, wherein the connection to the processor comprises an output from a clock gate register and the monitoring component is arranged to detect a clock gate signal indicating an idle loop task.

11. The system according to claim 7, further comprising one or more monitors arranged to detect the periodicity of an executing application and a power management unit arranged to adjust the processor frequency according to the detected periodicity.

12. The system according to claim 11, further comprising a feedback unit arranged to moderate the adjusting of the processor frequency according to the established ratio of processor idle time to processor busy time, according to the detected periodicity.
